(19) United States
(12) Patent Application Publication
(10) Pub. No.: US 2009/0096998 A1
(43) Pub. Date: Apr. 16, 2009

(54) PROJECTOR WITH ILLUMINATED LOGO REGION

(75) Inventors: WEN-FU WEN, Tu-Cheng (TW); KAI HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/106,527

(22) Filed: Apr. 21, 2008

(30) Foreign Application Priority Data
Oct. 11, 2007 (CN) 200710202023.0

(51) Int. Cl. G03B 21/28

(52) U.S. Cl. 353/98

(57) ABSTRACT

A projector equipped with an illuminated logo region includes a light source including a reflector defining an opening and a light-emitting portion contained by the reflector, a light-modulating device, a lens, a housing, and a logo region. The light-emitting portion emits light radially. Part of the light is emitted directly through the opening of the reflector and/or is reflected by the reflector through the opening to be received by the light-modulating device to be modulated to produce a projecting light before being received by the lens and then projected to form an image on a surface. Another part of the light is transmitted through the reflector to illuminate the logo region. The housing is configured for housing the light source, the light-modulating device, and the lens. The logo region is inlaid in a portion of the housing corresponding to the reflector, to be illuminated by the another part of light.

### BACKGROUND

1. Field of the Invention

The present invention relates to a projector with an illuminated logo region.

2. Description of related art

Usually, a logo is attached to a housing of a projector during manufacture so as to indicate a brand of the projector. In this way, a user of the projector and other observers may view the brand information while using the projector.

However, the projector is typically used in a completely dark or relatively dark environment. Thus, in these types of lighting conditions, people may be not able to see the logo attached to the housing.

### SUMMARY

The present invention relates to a projector equipped with an illuminated logo region. The projector includes a light source including a reflector defining an opening and a light-emitting portion contained by the reflector, a light-modulating device, a lens, a housing, and a logo region. The light-emitting portion emits light in a radial fashion. Part of the light is emitted directly through the opening of the reflector and/or is reflected by the reflector through the opening, to be received by the light-modulating device to be modulated to produce a projecting light before being received by the lens and then projected to form an image on a surface. Another part of the light is transmitted through the reflector to illuminate the logo region. The housing is configured for housing the light source, the light-modulating device, and the lens. The logo region is inlaid in a portion of the housing corresponding to the reflector, to be illuminated by the another part of the light.

Other advantages and novel features of the present invention will become more apparent from the following detailed description of present embodiments when taken in conjunction with the accompanying drawings.

### BRIEF DESCRIPTION OF THE DRAWINGS

FIG. 1 is a schematic view of a projector with an illuminated logo region according to a first exemplary embodiment.

FIG. 2 is a front view of an illuminated logo attached to the projector of FIG. 1.

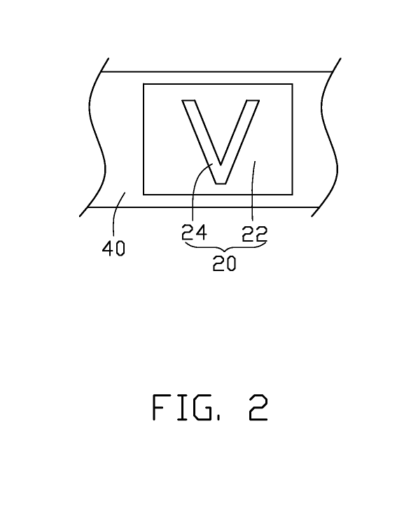

FIG. 3 is a schematic view of a projector with an illuminated logo region according to a second exemplary embodiment.

### DETAILED DESCRIPTION OF THE EMBODIMENTS

Reference will now be made to the figures to describe exemplary embodiments in detail.

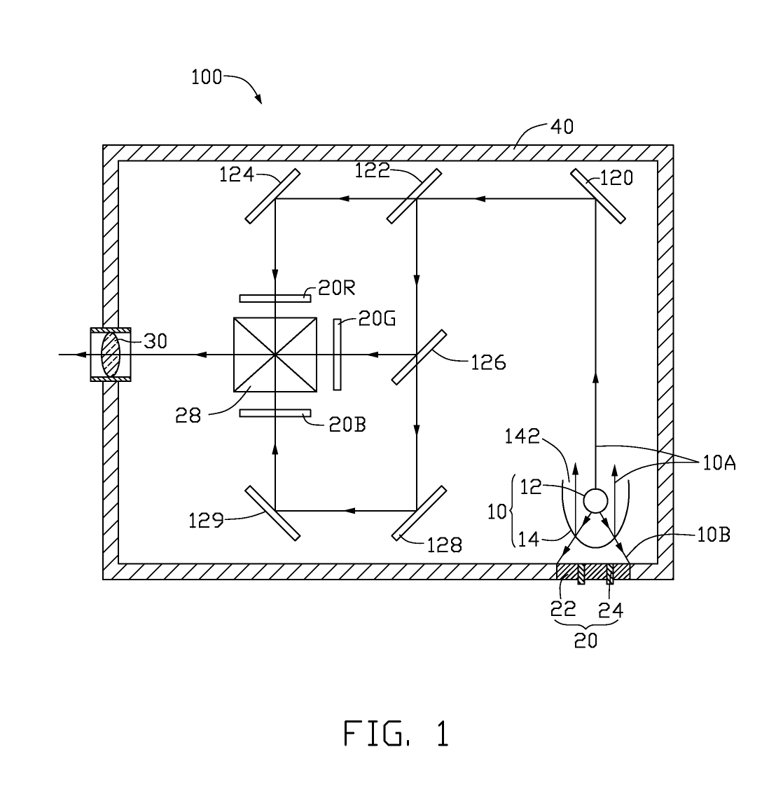

Referring to FIG. 1, a projector 100 equipped with a logo region 20, according to a first exemplary embodiment, is shown. As an example, the projector 100 may be an LCD projector. The projector 100 includes a light source 10, a splitter device, a light-modulating device, a combiner 28, a logo region 20, a lens 30, and a housing 40. The splitter device, the light-modulating device, the combiner 28, and the lens 30 are arranged along a light path associated with the light source 10 in that order. The housing 40 is configured for housing the light source 10, the splitter device, the light-modulating device, the combiner 28, and the lens 30.

The light source 10 includes a reflector 14 defining an opening 142 and a light-emitting portion 12 contained by the reflector 14. Beneficially, the reflector 14 is an elliptical-shaped reflector, and the light-emitting portion 12 may be positioned at a focal point of the elliptical-shaped reflector 14. Generally, the light-emitting portion 12 may be a metal halide lamp, a high-voltage mercury lamp, or a white light-emitting diode or other light source used in the projector 100. Part of the light 10A is emitted directly through the opening 142 of the reflector 14 and/or is reflected by the reflector 14 through the opening 142 to be received by the light-modulating device to be modulated to produce a projecting light before being received by the lens 30 and projected to form an image on a surface, e.g. a surface of a screen external to the projector 100. For convenient description, the part of the light 10A described above is called working light 10A in the following detailed description. Another part of the light 10B is transmitted through the reflector. The another part of the light 10B is called backlight 10B in the following detailed description. Generally, light emitted from the light-emitting portion 12 may be white light containing red, blue, and green light components.

The light-modulating device modulates the working light 10A to produce the projecting light. In the present embodiment, the light-modulating device includes a first liquid crystal (LC) panel 20R, a second LC panel 20B, and a third LC panel 20G. The splitter device includes a first reflector 120, a first splitter 122, a second reflector 124, a second splitter 126, a third reflector 128, and a fourth reflector 129. The working light 10A emitted from the light-emitting portion 12 may be reflected by the first reflector 120 towards the first splitter 122. The red light component contained in the working light 10A may be split by the first splitter 122 and propagated towards the second reflector 124, then reflected by the second reflector 124 toward the first LC panel 20R. The other two light components (blue and green) may be reflected by the first splitter 122 toward the second splitter 126. The green light component may be reflected by the second splitter 126 toward the third LC panel 20G. The blue light component may be separated from the working light 10A by the second splitter 126 and propagated toward the third reflector 128, then reflected by the third reflector 128 toward the fourth reflector 129 and finally reflected by the fourth reflector 129 toward the second LC panel 20B. The red, blue, and green light components are respectively modulated by the first LC panel 20R, the second LC panel 20B, and the third LC panel 20G, then combined by the combiner 28.

The combiner 28 is a combination of four triple prisms arranged in an “X” fashion. The combiner 28 combines the projecting light modulated by the light-modulating device. The projecting light is projected by the lens 30 to form an image on a screen.

The logo region 20 may be inlaid in a portion of the housing 40 adjacent to the reflector 14 of the light source 10. The logo region 20 may include a body 22 and a pattern 24 defined in and through the body 22. In this embodiment, the body 22 may be integrated with the pattern 24. The pattern 24 may be a name of a manufacturer, a trademark, or the like, which is a letter “V” in this present embodiment. The pattern 24 may be made of transparent material, while the body 22 may be made of opaque material, or transparent material made opaque by addition of some coating, for example, or vice versa.

The working light 10A may travel directly out of the reflector 14, and/or may be reflected by the reflector 14, and propagates toward the first reflector 120. However, the backlight 10B emitted from the light-emitting portion 12 may be transmitted through the reflector 14 to thereby illuminate the logo region 20. Therefore, in the dark environment, the pattern 24 of the logo region 20 is illuminated so that people may see the pattern 24 of the logo region 20.

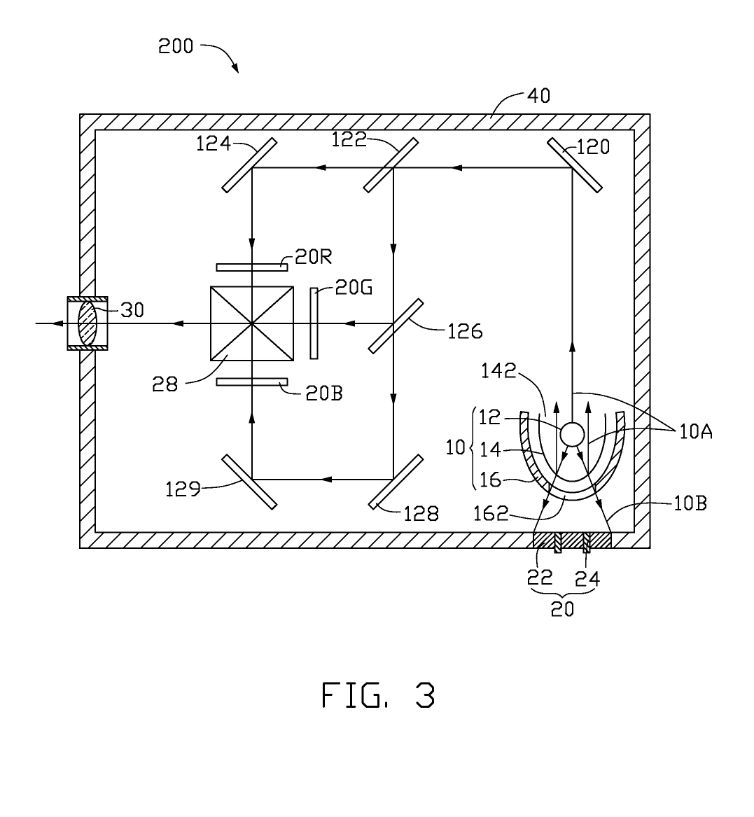

Referring to FIG. 3, a projector 200 with an illuminated logo region 20, according to a second exemplary embodiment, is shown. A difference between the projector 100 in the first embodiment and the projector 200 in the second embodiment is inclusion of a shade 16 in the projector 200.

The shade 16 is configured for shading light transmitted through the reflector 14, so as to block the backlight 10B transmitted through the reflector 14 to decrease influence on other optical elements, e.g. the LC panels 20R, 20G, 20B and the light path of the working light 10A in the projector 200. A portion of the shade 16 corresponding to the logo region 20 defines a through hole 162. Part of light transmitted through the reflector 14 goes through the through hole 162 to illuminate the logo region 20.

Since the logo region 20 is inlaid in a portion of the housing 40 adjacent to the reflector 14 of the light source 10, the logo region 20 is illuminated by the backlight 10B transmitted through the reflector 14. Thus, people can see the logo region 20 clearly in a dark environment.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A projector comprising:
a light source comprising:
a reflector defining an opening; and
a light-emitting portion contained by the reflector, the light-emitting portion emitting light radially;
a light-modulating device for receiving a part of the light emitted directly through the opening of the reflector and/or reflected by the reflector through the opening and modulating the part of the light to produce a projecting light;
a lens for projecting the projecting light to form an image on a surface;
a housing for housing the light source, the light-modulating device, and the lens; and
a logo region inlaid in a portion of the housing corresponding to the reflector and illuminated by another part of the light transmitted through the reflector.

2. The projector of claim 1, wherein the light-modulating device includes a first liquid crystal panel, a second liquid crystal panel, and a third liquid crystal panel, the projector further comprising a splitter device for splitting the part of the light emitted directly through the opening of the reflector and/or reflected by the reflector through the opening into three color light components respectively modulated by the first liquid crystal panel, the second liquid crystal panel, and the third liquid crystal panel.

3. The projector of claim 2, further comprising a combiner for combining the three light components after modulation by the light-modulating device to produce the projecting light.

4. The projector of claim 1, wherein the logo region includes a body and a pattern defined in and through the body, material of the body is opaque to the light emitted from the light-emitting portion, and material of the pattern is transparent to the light emitted from the light-emitting portion.

5. The projector of claim 1, wherein the logo region includes a body and a pattern defined in and through the body, material of the pattern is opaque to the light emitted from the light-emitting portion, and material of the body is transparent to the light emitted from the light-emitting portion.

6. The projector of claim 1, further comprising a shade having a portion corresponding to the logo region defining a through hole, the another part of the light transmitted through the reflector being transmitted through the through hole to illuminate the logo region.

7. The projector of claim 1, wherein the reflector is an elliptical-shaped reflector, and the light-emitting portion is positioned at a focal point of the elliptical-shaped reflector.
